(19) United States
(12) Patent Application Publication
(10) Pub. No.: US 2025/0188556 A1
(43) Pub. Date: Jun. 12, 2025

(54) METHOD FOR SLAG MODIFICATION DURING END PERIOD OF CASTING IN STEEL LADLE HAVING COVER

(71) Applicant: SOOCHOW UNIVERSITY, Suzhou (CN)

(72) Inventors: Shaoyan HU, Suzhou (CN); Deyong WANG, Suzhou (CN); Tianpeng QU, Suzhou (CN); Minqi SHENG, Suzhou (CN); Huihua WANG, Suzhou (CN); Jun TIAN, Suzhou (CN); Dong HOU, Suzhou (CN); Xianglong LI, Suzhou (CN); Lijuan SU, Suzhou (CN)

(21) Appl. No.: 18/012,645

(22) PCT Filed: Jan. 13, 2022
(86) PCT No.: PCT/CN2022/071886

§ 371 Date: Aug. 21, 2023

(30) Foreign Application Priority Data
Dec. 9, 2020 (CN) 202011433352.8

(51) Int. Cl. C21C 7/076; C21C 7/00; C21C 7/072

(52) U.S. Cl. CPC C21C 7/076; C21C 7/0075; C21C 7/072

(57) ABSTRACT

A method for slag modification method during the end period of casting in a steel ladle having a cover is disclosed. When the slag in a steel ladle is reducing slag, before casting, air is blown into the steel ladle by means of a bottom blowing brick, then casting is started, and during the end period of casting, bottom blowing of gas is stopped, and a carrier gas is used to spray a modifier into the steel ladle until casting is completed. When the slag is oxidizing slag, during the end period of casting, the carrier gas is used to spray the modifier into the steel ladle until casting is completed. The direction in which the modifier is sprayed is towards a steel outlet of the steel ladle, the modifier being lime, light calcined dolomite, magnesium balls, or recarburizer, and the particle size of the modifier being 3-10 mm.

### TECHNICAL FIELD

The invention belongs to the technical field of molten steel casting, and relates to a slag modification method in the end period of casting covered ladle.

### BACKGROUND ART

With the increasingly fierce market competition in the steel industry, the technical needs of iron and steel enterprises to reduce production costs and improve product quality are becoming more and more urgent. Swirl slag is a common phenomenon in the steel casting process, forming a whirlpool above the outlet at the final stage of casting, and the slag is swirled into the molten steel, which seriously undermines the cleanliness of molten steel and steel quality. In production practice, once a large area of slag rolls must stop casting, the remaining steel in the ladle can only be used as scrap back to the furnace smelting, resulting in a waste of resources. After the ladle is covered, the insulation effect of the ladle is significantly improved, and the heat dissipation on the surface of the slag is greatly reduced. However, although the ladle covering process can reduce the heat loss and energy consumption, it also exacerbates the swirling slag at the end of casting, resulting in a decline in the quality of steel, and an increase in the amount of residual steel. Therefore, it is very urgent and significant to develop an inhibitory technology for vortex slag entrainment under steel ladle cover-adding process conditions.

### TECHNICAL PROBLEM

In order to solve the above problems, the present invention proposes a method for slag modification during the end period of casting in steel ladle having a cover, so as to realize the inhibition of vortex slag entrainment under steel ladle cover-adding process conditions. When the slag in a steel ladle is reducing slag, during the process of casting of molten steel, the rotating speed of the molten steel is inhibited by bottom blowing gas, the bottom blowing gas is stopped at the end of casting, and a slag modifier is added to the upper part of the ladle outlet through the top of the ladle for slag modification, so as to inhibit the vortex slag entrainment and reduce the height of the initial slag entrainment; when the slag in a steel ladle is oxidizing slag, a slag modifier is added to the upper part of the ladle outlet through the top of the ladle for slag modification during the end period of casting, so as to inhibit the vortex slag entrainment and reduce the height of the initial slag entrainment.

### TECHNICAL SOLUTION

The invention adopts the following technical scheme: a method for slag modification during end period of casting in steel ladle having a cover. When the slag in the steel ladle is reducing slag, before casting, air is blown into the steel ladle by means of a bottom blowing brick, then casting is started, and during the end period of casting, bottom blowing of gas is stopped, and a carrier gas is used to spray a modifier into the steel ladle until casting is completed.

When the slag in the steel ladle is oxidizing slag, during the end period of casting, the carrier gas is used to spray the modifier into the steel ladle until casting is completed.

The direction in which the modifier is sprayed is towards a steel outlet of the steel ladle.

The modifier is one or more of lime, light calcined dolomite, magnesium ball, or recarburizer; and the particle size of the modifier is 3-10 mm, and the mass ratio of the modifier to the carrier gas is 5-10.

The invention discloses the application of the modifier in the inhibition of vortex slag entrainment under the steel ladle cover-adding process.

The invention preferably selects different operation steps according to the different properties of slag in the steel ladle. When the slag in the steel ladle is oxidizing slag, the bottom blowing is not required.

The invention uses the pneumatic conveying pipe to spray the modifier, which can be installed on the side side wall of the steel ladle with one end of the pneumatic conveying pipe located on the inner side of the opening of the steel ladle, above the highest level of the steel ladle and pointing to the steel outlet of the steel ladle and with the other end of the pneumatic conveying pipe connected with the modifier spraying device. The modifier is sprayed into the steel ladle through the pneumatic conveying pipeline, and the modifier outlet of the pneumatic conveying pipeline is towards the steel outlet of the steel ladle, thus the spraying direction of the modifier is towards the steel outlet of the steel ladle.

The creativity of the invention lies in that during the end of casting under the steel ladle cover-adding process, the modifier with specific component and specific particle size is sprayed to the upper part of the steel outlet of the steel ladle, and the modifier settles on the surface of the slag on the upper part of the steel outlet for modification, so as to inhibit the vortex slag entrainment. The invention first proposes a solution for the vortex slag entrainment under the steel ladle cover-adding process, which is a new idea for the inhibition of vortex slag entrainment; in addition, the creativity of the invention lies in the dynamic adjustment of the bottom blowing gas supply method according to different slag properties and different residual molten steel, which can further inhibit the vortex slag entrainment while improving the cleanliness of molten steel.

Further, during the casting process, the bottom blowing gas flow will be reduced with the reduction of the weight of the residual molten steel in the steel ladle. For example, the bottom blowing gas flow will be reduced by 0.8-1.2 Nm³/h for the reduction of every 25 t of molten steel.

In the present invention, the sum of the mass fractions of FeO and MnO in the reducing slag does not exceed 2%, otherwise it is oxidizing slag; during the end of casting, the level of molten steel in the steel ladle is 200-500 mm high, and the measurement is conventional technology.

In the invention, the bottom blowing gas is argon, and the carrier gas for spraying the modifier is any one or the mixture of nitrogen and argon.

Preferably, when the slag in the steel ladle is reducing slag, the modifier is a mixture of one of lime and magnesium ball and light calcined dolomite; when the slag in the steel ladle is oxidizing slag, the modifier is a mixture of one of lime, magnesium ball and light calcined dolomite and a recarburizer with the mass fraction of recarburizer no less than 30%, preferably 30%-80%; the recarburizer can be carbon particles.

### Beneficial Effects

The technical principles and beneficial effects of the invention are:
(1) To use the bottom blowing gas to drive the molten steel to flow up and down, inhibit the horizontal rotating flow of molten steel, and inhibit the formation and development of vortex;
(2) To spray carrier gas and modifier into the steel ladle during the end period of casting to inhibit the formation and development of vortex;
(3) After the adoption of the invention, the height of molten steel with initial slag entrainment under steel ladle cover-adding process can be lowered by about 50 mm, which can improve the quality of molten steel and reduce the amount of residual steel in the steel ladle.

### BRIEF DESCRIPTION OF THE DRAWINGS

FIG. 1 is a schematic view of steel ladle improvement for slag modification during the end period of casting in steel ladle having a cover of the present invention.

FIG. 2 is a schematic view of horizontal blowing at the outlet of the pneumatic conveying pipeline.

In the figures: 1. Steel ladle; 2. Steel ladle cover; 3. Molten steel; 4. Slag; 5, Bottom blowing brick; 6. Steel outlet; 7. Pneumatic conveying pipeline; 12. Modifier blowing device.

### EXAMPLES OF THE PRESENT INVENTION

In the existing technology, the steel ladle, especially the steel ladle having a cover, is not provided with pneumatic conveying pipeline and even not connected with pneumatic conveying pipeline and modifier spraying device (powder spraying device). In particular, the existing technology has no inhibition method for the vortex slag entrainment under the steel ladle cover-adding process, resulting in a high initial slag entrainment height and a large waste of molten steel; the slag modification during the end period of the casting in the steel ladle having a cover disclosed in the invention realizes the inhibition of vortex slag entrainment under steel ladle cover-adding process for the first time. The pneumatic conveying pipeline is installed on the side wall of the steel ladle for the first time and the steel outlet of the pneumatic conveying pipeline is located at the inner side of the opening of the steel ladle, above the highest level of the steel ladle and pointing to the steel outlet of the steel ladle, and the inlet of the pneumatic conveying pipeline is connected with the modifier spraying device; and pointing to the steel outlet of the steel ladle means that the modifier outlet of the pneumatic conveying pipeline faces downward, and the included angle between its axis and the horizontal plane is 30°-60°.

The existing operation method can't be applied for the recently gradually-used ladle having a cover, and the process method of adding powder such as converter can not be used for ladle having a cover, so the existing technology has no method for inhibiting slag entrainment in ladle having a cover. The creativity of the invention is to provide a new process, which uses the pneumatic conveying pipeline to spray the modifier towards the steel outlet during the end period of casting, and the modifier settles on the surface of the slag on the upper part of the steel outlet for modification to be gradually dissolved in the slag so as to inhibit the vortex slag entrainment. It is preferred that when the slag in the steel ladle is a reducing slag, the bottom gas is blown; the other methods are conventional methods. Through the creative work, the invention realizes the inhibition of vortex slag entrainment under steel ladle cover-adding process without other steps and devices. The method and timing of adding modifier and the cooperation between powder spraying and bottom blowing are not disclosed.

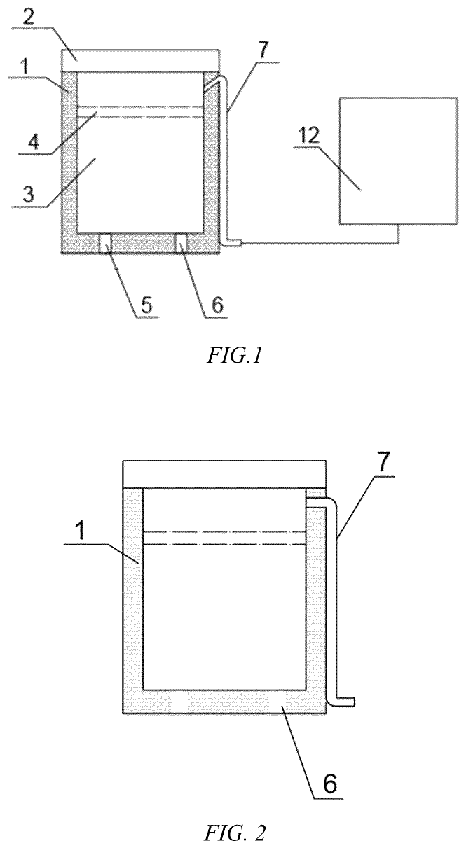

As shown in FIG. 1, the present invention uses the pneumatic conveying pipeline to spray the modifier. The existing steel ladle (1) is equipped with a ladle cover (2), the steel ladle is equipped with a bottom blowing brick (5) at the bottom for bottom blowing of gas, and the pneumatic conveying pipeline (7) is installed on the side wall of the steel ladle; one end of the pneumatic conveying pipeline is located on the inner side wall of the opening of the steel ladle, above the highest level of the steel ladle and pointing to the steel outlet (6) of the steel ladle to be used to spray all the modifier above the slag (4) more easily without affecting the composition and quality of the molten steel (3); the other end of the pneumatic conveying pipe is connected with the modifier spraying device (12). The specific connection and installation of each component is conventional technology. The steel ladle, pneumatic conveying pipeline and modifier spraying device are existing equipment or components, which can realize the purpose of the invention; pointing to the steel outlet of the steel ladle means that the modifier outlet of the pneumatic conveying pipeline faces downward, and the included angle between its axis and the horizontal plane is 45°, which is used for the following Examples.

### Example 1

The invention is applied to a 250t steel ladle in a steel plant, and the cover-adding process is applied for the steel ladle. The slag of casting steel grade B is reducing slag, in which the mass fraction of (FeO) and (MnO) is less than 1% and the operation steps of the invention are:
(1) Place the steel ladle on the ladle turntable according to the existing operation, then turn on the bottom blowing air supply device, and blow the gas into the steel ladle through the bottom blowing brick. The bottom blowing gas is chlorine, and the bottom blowing flow is 10 Nm³/h;
(2) According to the existing operation, rotate the ladle turntable, place the steel ladle in the casting position, open the steel outlet of the steel ladle, and then the ladle starts casting;
(3) The bottom blowing air supply device dynamically adjusts the bottom blowing gas flow, and the gas flow will be reduced with the reduction of the weight of the residual molten steel in the steel ladle. When the weight of molten steel is reduced by every 25t, the bottom blowing gas flow is reduced by 1 Nm³/h;
(4) When the level of molten steel in the ladle is 250 mm high, stop the bottom blowing, turn on the modifier spraying device, use argon as carrier gas, and spray the modifier into the ladle until the casting is completed. The modifier is composed of lime particles with a diameter of 5-10 mm and light calcined dolomite particles (weight ratio of 1:1). The spraying flow of the modifier is 200 kg/min, and the mass ratio of the modifier and carrier gas is 8.0. Under the action of gravity, the modifier settles on the surface of the slag on the upper part of the steel outlet and gradually dissolves and modifies the slag, thus inhibiting the vortex slag entrainment. The height of initial slag entrainment of the steel grade B cast in steel ladle drops to 85-90 mm, which is significantly lower than the height of 140 mm-150 mm of initial slag entrainment of the existing process.

### Example 2

The invention is applied to a 250t steel ladle in a steel plant, and the cover-adding process is applied for the steel ladle. The slag of casting steel grade B is reducing slag, in which the mass fraction of (FeO) and (MnO) is less than 1% and the operation steps of the invention are:
(1) Place the steel ladle on the ladle turntable according to the existing operation, then turn on the bottom blowing air supply device, and blow the gas into the steel ladle through the bottom blowing brick. The bottom blowing gas is argon, and the bottom blowing flow is 10 Nm³/h, which is maintained constantly;
(2) According to the existing operation, rotate the ladle turntable, place the steel ladle in the casting position, open the steel outlet of the steel ladle, and then the ladle starts casting;
(3) When the level of molten steel in the steel ladle is 250 mm high, stop the bottom blowing, turn on the modifier spraying device, use argon as carrier gas, and spray the modifier into the ladle until the casting is completed. The modifier is composed of lime particles with a diameter of 5-10 mm and light calcined dolomite particles (the weight ratio is 1:1). The spraying flow of the modifier is 200 kg/min, and the mass ratio of the modifier and carrier gas is 8.0. Under the action of gravity, the modifier settles on the surface of the slag on the upper part of the steel outlet and gradually dissolves and modifies the slag, thus inhibiting the vortex slag entrainment. The height of initial slag entrainment of the steel grade B cast in steel ladle drops to 100-110 mm. However, the constant flow of bottom blowing argon in the whole process leads to the exposure of molten steel and serious secondary oxidation of molten steel. Especially due to the strong stirring effect of the bottom blowing gas, slag entrainment occurs at the slag-steel interface above the bottom blowing brick, which seriously affects the quality of molten steel, so this method does not meet the requirements of steelmaking.

### Comparative Example 1-1

On the basis of Example 1, the bottom blowing is closed in the whole process and the rest remains unchanged, the height of initial slag entrainment of the steel grade B cast in the steel ladle casting drops to 110-120 mm.

### Comparative Example 1-2

On the basis of Example 1, the modifier is not sprayed and the rest remains unchanged, the height of initial slag entrainment of the steel grade B cast in the steel ladle casting drops to 130-140 mm.

Example 3

The invention is applied to a 250t steel ladle in a steel plant, and the cover-adding process is applied for the steel ladle. The slag of casting steel grade A is oxidizing slag, in which the sum of mass fraction of (FeO) and (MnO) is 21-23% and the operation steps of the invention are:
(1) Place the steel ladle on the ladle turntable according to the existing operation, rotate the ladle turntable, place the steel ladle in the casting position, open the steel outlet of the steel ladle, and then the ladle starts casting;
(2) When the level of molten steel in the ladle is 300 mm high, turn on the modifier spraying device, use nitrogen as carrier gas, and spray the modifier into the ladle until the casting is completed; the modifier is composed of carbon particles with a diameter of 5-10 mm and light calcined dolomite particles (the mass fraction of carbon particles is 50%). The spraying flow of the modifier is 200 kg/min, and the mass ratio of the modifier and carrier gas is 8.0. Under the action of gravity, the modifier is sprayed out of the pneumatic conveying pipeline and settles on the surface of the slag on the upper part of the steel outlet to inhibit the vortex slag entrainment. The height of the initial slag entrainment of the steel grade A cast in steel ladle drops to 100-105 mm.

### Comparative Example 3-1

A cover-adding process is applied for a 250t steel ladle in a steel plant. The slag of casting steel grade A is oxidizing slag, in which the sum of mass fraction of (FeO) and (MnO) is 21-23% and the operation steps are as follows:
(1) Place the steel ladle on the ladle turntable according to the existing operation, then turn on the bottom blowing air supply device, and blow the gas into the steel ladle through the bottom blowing brick. The bottom blowing gas is argon, and the bottom blowing flow is 10Nm³/h.
(2) According to the existing operation, rotate the ladle turntable, place the steel ladle in the casting position, open the steel outlet of the steel ladle, and then the ladle starts casting.
(3) The bottom blowing air supply device dynamically adjusts the bottom blowing gas flow, and the gas flow will be reduced with the reduction of the weight of the residual molten steel in the steel ladle. When the weight of molten steel is reduced by every 25t, the bottom blowing gas flow is reduced by 1 Nm³/h.

(4) When the level of molten steel in the steel ladle is 300 mm high, stop the bottom blowing, turn on the modifier spraying device, use chlorine as carrier gas, and spray the modifier into the ladle until the casting is completed. The modifier is composed of carbon particles with a diameter of 5-10 mm and light calcined dolomite particles (the mass fraction of carbon particles is 50%). The spraying flow of the modifier is 200 kg/min, and the mass ratio of the modifier and carrier gas is 8.0. Under the action of gravity, the modifier is sprayed out of the pneumatic conveying pipeline and settles on the surface of the slag on the upper part of the steel outlet to inhibit the vortex slag entrainment. The height of the initial slag entrainment of the steel grade A cast in steel ladle drops to 110-120 mm. Although it can also lower the height of the initial slag entrainment, it has brought about the following serious problems: the bottom blowing gas enhances the reaction kinetic conditions between molten steel and slag, the oxidizing slag transfers oxygen to molten steel, and the alloy elements in molten steel are burned by a large amount of oxidation, resulting in the unqualified composition of the cast billet. Therefore, although this method can inhibit the vortex slag entrainment, it also brings about serious problems of the composition and quality of molten steel, which causes more harm than good and does not meet the requirements of steelmaking.

### Comparative Example 3-2

A 250t steel ladle in a steel plant, and the cover-adding process is applied for the steel ladle. The slag of casting steel grade A is oxidizing slag, in which the sum of mass fraction of (FeO) and (MnO) is 21-23% and the existing operation steps are as follows: Place the steel ladle on the ladle turntable, rotate the ladle turntable, place the ladle in the casting position, open the steel outlet of the steel ladle, and the steel ladle starts casting; these are all routine casting steps.

Before the application of the invention and under the existing method, the height of the initial slag entrainment of steel grade A caste in the steel ladle is 150-160 mm, and the weight of the residual molten steel in the steel ladle is about 11-12 t.

### Comparative Example 3-3

On the basis of the Example 3, the modifier is changed from carbon particles with a diameter of 5-10 mm and light calcined dolomite particles to all carbon particles with a diameter of 5-10 mm. Under the same process, the height of initial slag entrainment of steel grade A cast in the steel ladle drops to 120-125 mm.

### Comparative Example 3-4

On the basis of the Example 3, the modifier is changed to carbon particles with a diameter of 5-10 mm and light calcined dolomite particles (the mass fraction of carbon particles is 50%). Under the same process, the height of initial slag entrainment of steel grade A cast in the steel ladle drops to 115-125 mm.

The above two Comparative Examples show that the proportions of modifier have impacts on the inhibition of the slag entrainment under the same particle size.

### Comparative Example 3-5

On the basis of the Example 3, the modifier is changed from the diameter of 5-10 mm to 0.1-1 mm. Under the same process, the height of initial slag entrainment of steel grade A cast in the steel ladle drops to 135-140 mm, and a large amount of modifier overflows with the furnace gas, which not only results in low yield but also causes dust pollution.

### Comparative Example 3-6

On the basis of the Example 3, keep the spraying flow of the modifier at 200 kg/min, and increase the mass ratio of the modifier to the carrier gas from 8.0 to 20. Under the same process, the modifier cannot be stably sprayed into the steel ladle, and the height of initial slag entrainment of steel grade A cast in the steel ladle drops to 125-130 mm.

### Comparative Example 3-7

The outlet of the modifier of the pneumatic conveying pipeline is horizontal, and its axis is parallel to the horizontal plane, as shown in FIG. 2. In this way, the spraying direction of the modifier does not face the steel outlet of the steel ladle, and the rest remains unchanged, which is used for the same process in the Example 3, and the height of initial slag entrainment of steel grade A cast in the steel ladle drops to 120-130 mm.

1. A method for slag modification in an end period of casting covered ladle, wherein:
when a slag in the steel ladle is reducing slag, before casting, air is blown into the steel ladle by means of a bottom blowing brick, then casting is started, and during the end period of casting, bottom blowing of gas is stopped, and a carrier gas is used to spray a modifier into the steel ladle until casting is completed;
when the slag in the steel ladle is oxidizing slag, during the end period of casting, the carrier gas is used to spray the modifier into the steel ladle until casting is completed;
a direction in which the modifier is sprayed is towards a steel outlet of the steel ladle;
the modifier is one or more of lime, light calcined dolomite, magnesium ball, or recarburizer; and a particle size of the modifier is 3-10 mm.

2. The method for slag modification during end period of casting in steel ladle having cover according to claim 1, wherein: the height of the molten steel in the steel ladle during the end period of casting is 200-500 mm.

3. The method for slag modification during end period of casting in steel ladle having cover according to claim 1, wherein: during the casting, the flow rate of bottom blowing gas is reduced with the reduction of the weight of the residual molten steel in the steel ladle.

4. The method for slag modification during end period of casting in steel ladle having cover according to claim 1, wherein: in the reducing slag, the sum of the mass fraction of FeO and MnO does not exceed 2%.

5. The method for slag modification during end period of casting in steel ladle having cover according to claim 1, wherein: when the slag in the steel ladle is reductive slag, the modifier is a mixture of one of lime and magnesium ball and light calcined dolomite; when the slag in the steel ladle is oxidizing slag, the modifier is a mixture of one of lime, magnesium ball and light calcined dolomite and a recarburizer with the mass fraction of recarburizer no less than 30%.

6. The method for slag modification during end period of casting in steel ladle having cover according to claim 1, wherein: the mass ratio of the modifier to the carrier gas is 5-10.

7. The method for slag modification during end period of casting in steel ladle having cover according to claim 1, wherein: the bottom blowing gas is argon.

8. The method for slag modification during end period of casting in steel ladle having cover according to claim 1, wherein: the carrier gas is any one or a mixture of nitrogen and argon.

9. An application of a modifier in the inhibition of vortex slag entrainment under steel ladle cover-adding process, wherein: the modifier is one or more of lime, light calcined dolomite, magnesium ball, or recarburizer; and a particle size of the modifier is 3-10 mm.

10. The application according to claim 9, wherein: when the slag in the steel ladle is reducing slag, the bottom blowing of gas is started before adding the modifier.
